(19) United States
(12) Patent Application Publication
(10) Pub. No.: US 2012/0284421 A1
(43) Pub. Date: Nov. 8, 2012

(54) PICTURE IN PICTURE FOR MOBILE TV

(76) Inventors: Shiyuan Xiao, Shanghai (CN); Jia Liu, Shanghai (CN); Yicheng Wu, Shanghai (CN); Yunjie Lu, Shanghai (CN)

(21) Appl. No.: 13/518,995

(22) PCT Filed: Dec. 25, 2009
(86) PCT No.: PCT/CN09/01554

§ 371 Date: Jun. 25, 2012

(51) Int. Cl. G06F 15/16

(52) U.S. Cl. 709/231

(57) ABSTRACT

The invention discloses a method, a terminal and a media server for supporting Picture in Picture (PiP) in a communication network. The method comprises sending to a media server (200) a first request (306) to setup a first channel streaming session, sending to the media server (200) a second request (310) to setup and a second channel streaming session, and rendering first channel content and second channel content as streamed over the first channel streaming session and the second channel streaming session at the same time.

### TECHNICAL FIELD

The present invention generally relates to Picture in Picture (PiP), and more particularly, to a system and method for supporting PiP for IP-based mobile TV.

### BACKGROUND

Picture in Picture (PiP) is a useful feature which is widely used in some traditional television receivers. One channel is displayed on the full TV screen and at the same time one or more other channels are displayed in smaller inset window(s). But the audio is usually from the main program only.

The traditional PiP feature requires two independent tuners or signal sources to supply the large and the small pictures. A two-tuner PiP TV has a second tuner built in, while a single-tuner PiP TV requires an external signal source, which may be, for example, an external tuner, VCR, DVD player, or a cable box with composite video outputs. A user often uses PiP to watch one program while keeping an eye on another. For example, a football fan may watch a game involving the team he supports in the main channel, while using PiP to keep track of games between other teams.

IP-base mobile TV is becoming popular recently due to the rapid development of mobile communication technology. It brings TV services to the mobile screen, but it is much more than traditional TV moved to a tiny screen. It provides the freedom of watching TV content whenever and wherever you are.

As one of the main branch of Mobile TV service, IP based mobile TV provides more flexibilities and more personalized services like VoD. The IP-based mobile TV service uses a series protocols, most dominant of which are introduced as follows.

Session Description Protocol (SDP)

SDP conveys information about media streams in multimedia sessions to allow recipients of a session description to participate in the session. In order to let a recipient have sufficient information to join a multimedia session, a SDP file generally includes:
Session name and purpose
Period during which the session is active
The media that is associated with the session
Other necessary information for receiving those media (address, ports, format and so on)

Real-Time Transport Protocol (RTP) and RTP Control Protocol (RTCP)

For streaming delivery, most real-time media will use RTP as a transport protocol. RTP provides end-to-end delivery services for streaming delivery with real-time characteristics. and transportation quality is secured by RTCP.

RTP carries data with real-time characteristics, and RTCP monitors the quality of service and conveys information in an on-going session.

Real-Time Streaming Protocol (RTSP)

RTSP is used to establish and control either a single or several time-synchronized streams of continuous media such as audio and video through different pre-defined method such as DESCRIBE, SETUP, PAUSE, PLAY, TEARDOWN and so on. The set of streams to be controlled is defined by SDP file.

Firstly the client send RTSP DESCRIBE request to fetch the SDP file corresponding to the resource identified by URL. Then the client will parse the SDP file and get all media information (video, audio, etc) included in this resource. Then, the client will dynamically setup each media according to its need with RTSP SETUP method. After that, the client will send RTSP PLAY request to the streaming server for a start of streaming. Finally, the client enjoys the media requested by itself.

For the current MTV solution, there is a limitation that users can only watch one channel at the same time and it is impossible for users to navigate other channels in parallel.

Most Mobile TV solutions support channel switch, but channel switch speed is much slower than traditional TVs due to the buffer time of streaming. So the current solutions can not give user a good experience especially in following case, eg. two important matches start at the same time.

### SUMMARY

There is no known PiP solution for Mobile TV at present.

Therefore, it is an object of the present invention to develop a Picture in Picture solution for mobile TV, particularly for those IP-based terminals and servers of mobile data access.

According one aspect of the invention, a method for implementing Picture in Picture (PiP) in an IP-based system by a terminal is provided. The method comprising the steps of sending to a media server a first request to setup a first channel streaming session, sending to the media server a second request to setup and a second channel streaming session, and rendering first channel content and second channel content as streamed over the first channel streaming session and the second channel streaming session at the same time.

The first channel content may have a higher quality than the second channel content.

The method may further comprise the step of requesting access information of the first channel and the second channel.

The first channel content may be rendered in a main window and the second channel content may be rendered in a minor window. The first channel streaming session and the second streaming session may be based on Real-Time Streaming Protocol (RTSP) and Real-time Transport Protocol (RTP). The first request and the second request may include at least one of RTSP DESCRIBE, SETUP and PLAY requests.

The first channel content and the second channel content may include at least one of video, audio and text. The video may be a sequence of Joint Photographic Experts Group (JPEG) images. At least one parameters for the first channel content and the second channel content may be adjustable.

The method may further comprise the step of sending to the media server a third request to switch from the second channel content of lower quality to a second channel content of higher quality over the second channel streaming session.

According another aspect of the invention, a method for implementing PiP in an IP-based system by a media server is provided, The method comprises the steps of setting up a first channel streaming session with a terminal in response to a first request from the terminal, and setting up a second channel streaming session with the terminal in response to a second request from the terminal.

According a further aspect of the invention, a terminal which supports PiP in an IP-based system is provided. The terminal comprises a session manager arranged for setting up channel streaming sessions with a media server, a first decoder arranged for decoding a first channel content which is streamed over a first channel streaming session, a second decoder arranged for decoding a second channel content which is streamed over a second channel streaming session, and a rendering engine arranged for rendering the first channel content and the second channel content at the same time.

The first channel content may have a higher quality than the second channel content.

The session manager may send to the media server a first request to setup the first channel streaming session and send to the media server a second request to setup the second channel streaming session. The session manager may request access information of the first channel and the second channel.

The first channel content may be rendered in main window and the second channel content may be rendered in minor window.

The first channel streaming session and the second streaming session may be based on RTSP and RTP. The first request and the second request may include at least one of RTSP DESCRIBE, SETUP and PLAY requests.

The first channel content and the second channel content may include at least one of video, audio and text. The video is a sequence of JPEG images. At least one parameters among resolution, bitrate and FPS of the first channel content and the second channel content may be adjustable.

The session manager may send to the media server a third request to switch from the second channel content of lower quality to a second channel content of higher quality over the second channel streaming session.

According to a further aspect of the invention, a media server which supports PiP in an IP-based system is provided. The media server comprises a media manager arranged for setting up channel streaming sessions with a terminal, a first encoder arranged for encoding a first channel content, and a second encoder arranged for encoding a second channel content.

According to a further aspect of the invention, an IP-based system which supports Picture in Picture (PiP) is provided. The system comprises a terminal and a media server as described above.

According one aspect of the invention, a method for implementing Picture in Picture (PiP) by a terminal is provided. Said method comprises the steps of sending to a media server a first request to setup a first channel streaming session and sending to the media server a second request to setup a second channel streaming session while the first channel streaming session is being setup.

The method may further comprise the step of getting and parsing access information of the first channel and the second channel.

The method may further comprise the step of sending to the media server a third request to switch to the second channel.

The first channel may be main channel and the second channel may be minor channel. The first channel streaming session and the second streaming session may be based on Real-Time Streaming Protocol (RTSP). The first request and the second request may include at least one of RTSP DESCRIBE, SETUP and PLAY requests.

The first request may have a Uniform Resource Locator (URL) of the first channel and the second request may have a URL of the second channel.

A sequence of JPEG pictures may be transmitted over the second channel streaming session. The JPEG picture may be packaged as RTP data.

According another aspect of the invention, a method for implementing Picture in Picture (PiP) by a media server is provided. Said method comprises the steps of setting up a first channel streaming session with a terminal in response to a first request from the terminal; and while setting up the first channel streaming session, setting up a second channel streaming session with the terminal in response to a second request from the terminal.

The method may further comprises the step of switching to the second channel in response to a third request from the terminal. The first channel may be main channel and the second channel may be minor channel.

The first channel streaming session and the second streaming session may be based on Real-Time Streaming Protocol (RTSP). The first request and the second request may include at least one of RTSP DESCRIBE, SETUP and PLAY requests, and the media server may response the requests with RTSP RESPONSE. The first request may have a Uniform Resource Locator (URL) of the first channel and the second request may have a URL of the second channel.

A sequence of JPEG pictures may be transmitted over the second channel streaming session. The JPEG picture may be packaged as RTP data.

According to a further aspect of the invention, a terminal which supports Picture in Picture (PiP) is provided. Said terminal comprises a session manager arranged for setting up channel streaming sessions with a media server, a first decoder arranged for decoding a first channel when a first channel streaming session is set up, and a second decoder arranged for decoding a second channel when a second channel streaming session is set up.

The session manager may send to the media server the first request to setup the first channel streaming session and send to the media server a second request to setup the second channel streaming session while the first channel streaming session is being setup.

The session manager may get and parse access information of the first channel and the second channel. The session manager may send to the media server a third request to switch to the second channel.

The first channel may be main channel and the second channel may be minor channel.

The first channel streaming session and the second streaming session may be based on Real-Time Streaming Protocol (RTSP). The first request and the second request may include at least one of RTSP DESCRIBE, SETUP and PLAY requests. The first request may have a Uniform Resource Locator (URL) of the first channel and the second request may have a URL of the second channel.

The second decoder may decode a sequence of JPEG pictures over the second channel streaming session. The JPEG picture may be packaged as RTP data.

According a further aspect of the invention, a media server which supports Picture in Picture (PiP) is provided. Said media server comprises media manager arranged for setting up channel streaming sessions with a terminal, a first encoder arranged for encoding a first channel, and a second decoder arranged for encoding a second channel.

The media manager may set up a first channel streaming session with the terminal in response to a first request from the terminal, and while setting up the first channel streaming session, set up a second channel streaming session with the terminal in response to a second request from the terminal.

The media manager may switch to the second channel in response to a third request from the terminal.

The first channel may be main channel and the second channel may be minor channel.

The first channel streaming session and the second streaming session may be based on Real-Time Streaming Protocol (RTSP). The first request and the second request may include at least one of RTSP DESCRIBE, SETUP and PLAY requests, and the media server responses the requests with RTSP RESPONSE. The first request may have a Uniform Resource Locator (URL) of the first channel and the second request may have a URL of the second channel.

The second encoder may encode a sequence of JPEG pictures for the second channel streaming session. The JPEG picture may be packaged as RTP data.

According to a further aspect of the invention, a system which supports Picture in Picture (PiP) is provided, which comprises a terminal and a media server as stated in the preceding text.

### BRIEF DESCRIPTION OF THE DRAWINGS

The invention, together with further objects and advantages thereof, will be best understood by reference to the following description taken together with the accompanying drawings, in which:

FIG. 1 is a screenshot showing a main channel and minor channel;

FIG. 2 is a representative system overview according to an embodiment of the invention;

FIG. 3 is an illustrative sequence diagram showing the interactions between the terminal 100 and the media server 200 for implementing the PiP function according to an embodiment of the invention; and

FIG. 4 is a representative system overview according to another embodiment of the invention.

### DETAILED DESCRIPTION

Throughout the drawings, the same reference characters will be used for corresponding or similar elements.

Before describing various embodiments in detail, it is to be understood that this invention is not limited to the particular component parts of the devices described or process steps of the methods described as such devices and methods may vary. It is also to be understood that the terminology used herein is for purposes of describing particular embodiments only, and is not intended to be limiting. It must be noted that, as used in the specification and the appended claims, the singular forms “a”, “an” and “the” may also encompass plural referents unless the context clearly dictates otherwise. Thus, for example, the term “a terminal” may refer to one or more terminals, and the like.

Briefly described, a method and an arrangement are provided for supporting PiP for IP-based mobile TV. The term “terminal” used herein may mean a mobile terminal, e.g. a mobile or cellular phone, laptop, PDA or mobile TV, but it may also mean some other type of terminal possible to connect to a communication network and play streaming media data. The term media server used herein may mean a server which stores or have access to media data and is able to provide it to terminals using streaming.

Although the embodiments of the present invention is illustrated in context of the 3^{rd} Generation Partnership Project (3GPP) Packet Switching Service (PSS) mobile TV system, the teaching of the present invention can also be applied to other communication systems, such as broadcast-based or unicast-based IPTV, Video On Demand (VOD) or video conference systems. In the embodiments the content is shown as TV program, however, it should not be limited to this. It can be any media of any form that can be delivered by the media server and rendered at the terminal, including, but being not limited to, movie, sport event or living concert in the form of image, video, audio, subtitle, etc. In the figures, the media session is performed as an RTSP session and therefore the terminology of such RTSP requests and responses have been employed in the figures and corresponding description. The teaching of the present invention could also be applied to other protocols used for setting up and managing a media session.

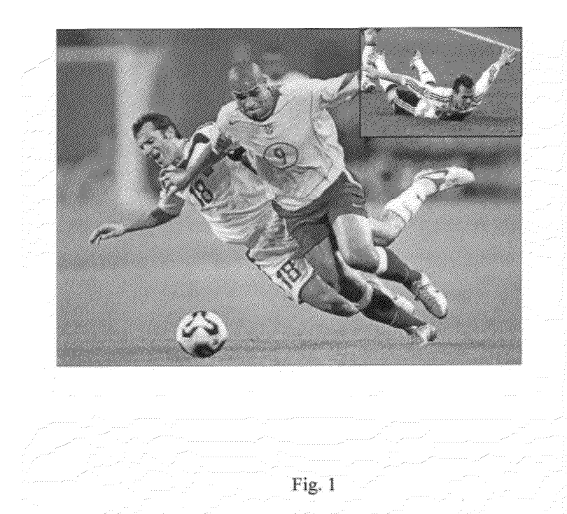

FIG. 1 is an example of a screen including a main channel and minor channel.

As shown in FIG. 1, a user may watch a game involving his favorite team or player on a so-called main channel, and keep track of another game on a so-called minor channel.

Generally, the main channel is shown in main window of mobile phone screen and uses most network bandwidth. Typically, the main channel may have both video and audio, and have high quality requirement for video. The codec of video could be H.263, MPEG-4, H.264 and others.

The minor channel is shown in a smaller window which overlaps on the main window and uses less network bandwidth. Typically, the minor channel may have video only and the quality of video is not so high as that of the main channel in consideration of saving bandwidth and processing power. However, it should be noted that the above example is for illustrative purpose only, in principle the number of channels (windows) that are displayed on the screen can be more than two. In the context the channels are indicated as “main channel” and “minor channel”, but they may have video or audio of arbitrary size, format and quality.

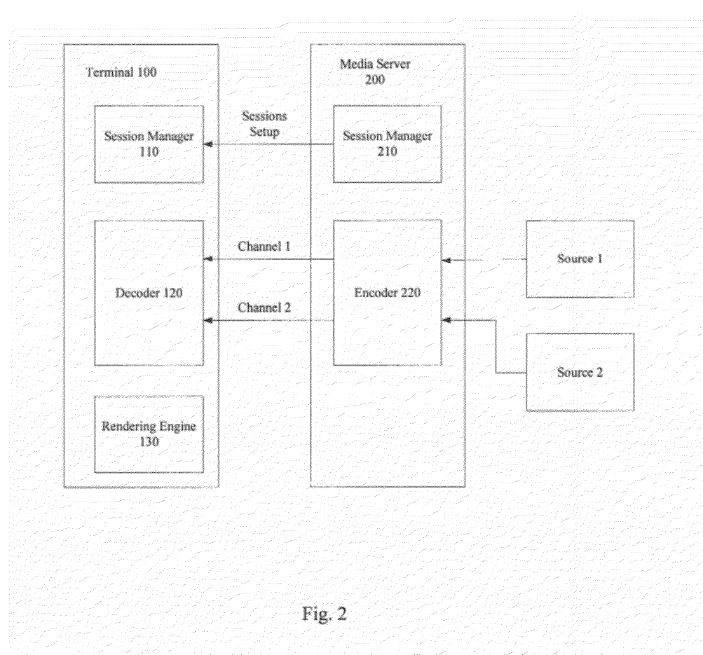

With reference to FIG. 2, a representative system overview according to an embodiment of the invention will be described.

We only consider that the PiP solution is applied for two live channels herein below although it can be applied for the case of more live channels or video on demand and other user cases.

As shown in FIG. 2, a system 100 that supports PiP includes a terminal 100 and a media server 200. The media server 200 provides streaming delivery services towards the terminal 100. It includes a session manager 210 and an encoder 220. The encoder 220 receives signals from external Sources and encode them into channel contents by e.g. H.264. FIG. 2 illustratively shows that the encoder 220 encodes signals from Source 1 and Source 2 into Channel 1 content and Channel 2 content respectively. The session manager 210 manages streaming communication between the media server 200 and the terminal 100, and delivers the encoded channel contents to the terminal 100 on request. Alternatively, the encoder 220 may be located outside the media server 200. For example, it may be implemented in a set-top box that receives TV signals from the cable network. Although the contents are shown as TV programs received from the external sources, they could be any suitable contents that are stored in the media server 200.

The terminal 100, such as a 3GPP PSS mobile phone, is capable of streaming channel contents such as TV programs from the media server 200 via wireless connection and rendering them on its screen. The terminal 100 includes a session manager 110, a decoder 120 and a rendering engine 130. The session manager 110 cooperates with the session manager 210 of the media server 200 to request and receive the encoded channel contents, i.e. Channel 1 and Channel 2 contents, from the media server 200. The decoder 120 then decodes the encoded Channel 1 and Channel 2 contents respectively. The rendering engine 130 supports overlay of the decoded channel contents so that both channel contents may be displayed on the screen of the terminal 100, i.e. PiP is implemented.

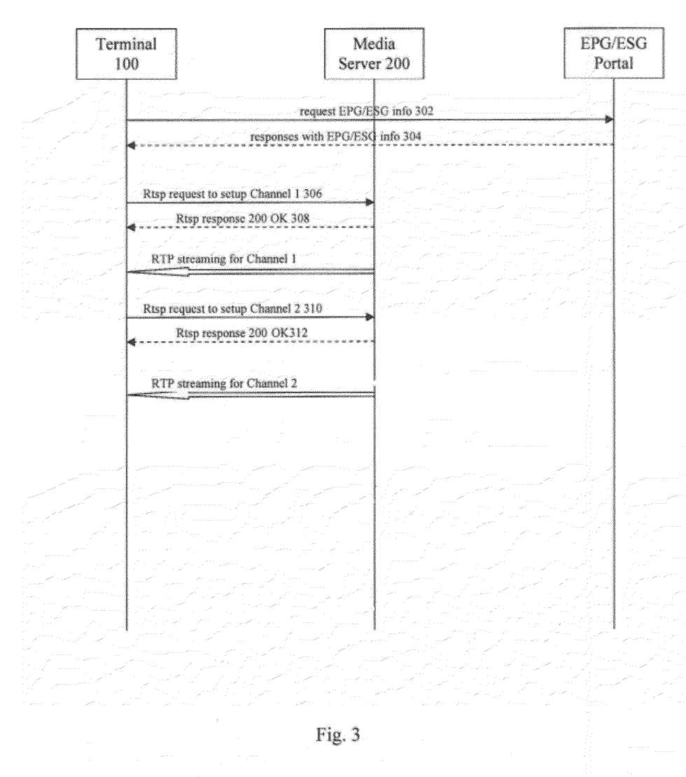

FIG. 3 is an illustrative sequence diagram showing the interactions between the terminal 100 and the media server 200 for implementing the PiP function according to an embodiment of the invention.

We consider a case that two channels, i.e. Channel 1 and Channel 2, are set up between the terminal 100 and the media server 200 and displayed in PiP on the screen of the terminal 100. Before setting up the two channels, the terminal 100 may get the their channel information access information first. There are many kinds of solution to announce the channel access information, e.g. the terminal may use a separate HTTP signal to request channel access information. In order to integrate with traditional Mobile TV solution seamlessly, we may integrate the channel access information with EPG (Electronic program Guide)/ESG (Electronic Service Guide). In Step 302, the terminal 100 requests access information, e.g. EPG/ESG of Channel 1 and Channel 2 from an external EPG/ESG portal so that the user of the terminal 100 may select Channel 1 and/or Channel 2 with such access information. Typically, the terminal 100 gets access information of all available channels at a time. The EPG/ESG portal responses with EPG/ESG information in step 304. Below is an example of EPG/ESG information:

```
<channel>
    <name>CCTV-5</name>
    other elements......
    <url>rtsp://streaming.cctv.com/programs/cctv5.sdp</url>
    <url2>rtsp://streaming.cctv.com/programs/cctv5-minor.sdp</url2>
</channel>
```

In Step 306, the terminal 100 sends RTSP DESCRIBE, SETUP, PLAY requests with the Channel 1 URL to the media server 200 respectively to setup Channel 1 streaming session and play the Channel 1 content. The media server 200 responses with RTSP 200 OK in Step 308, and then RTP streams the Channel 1 content as encoded by the encoder 220 to the terminal 100. The terminal 100 may render the Channel 1 content on its screen by using the rendering engine 130. Typically, the terminal 100 sends RTSP DESCRIBE, SETUP, PLAY requests in sequence using session manager 110, and the media server 200 responses each request with RTSP 200 OK using session manager 210, although the interaction between the terminal 100 and the media server 200 is shown as two steps 306 and 308 for purpose of simplicity. Below is an example showing in detail the interaction for setting up and playing the Channel 1 streaming session.

```
C->s: DESCRIBE rtsp://streaming.cctv.com/programs/cctv5.sdp RTSP/1.0
      CSeq: 0
      Accept: application/sdp
S->C: RTSP/1.0 200 OK
      CSeq: 0
      Content-base: rtsp://streaming.cctv.com/programs/cctv5.sdp /
      Content-length: 412
      Content-type: application/sdp
      Date: Fri, 16 Jun 2006 17:48:54 GMT
      v=0
      o=− 750672 750672 IN IP4 10.128.16.106
      s=<No title>
      c=IN IP4 0.0.0.0
      t=0 0
      a=SdpplinVersion:1610641560
      a=StreamCount:integer;2
      a=control:*
      a=LiveStream:integer;1
      m=video 0 RTP/AVP 96
      a=control:streamid=0
      a=rtpmap:96 MP4V-ES/90000
      a=fmtp:96 profile-level-id=8;
      a=mimetype:string;“video/MP4V-ES”
      m=audio 0 RTP/AVP 97
      a=control:streamid=1
      a=rtpmap:97 AMR/8000
      a=fmtp:97 octet-align=1
      a=mimetype:string;“audio/AMR”
      a=mpeg4-esid:101
C->S:  SETUP rtsp://streaming.cctv.com/programs/cctv5.sdp/streamid=0
RTSP/1.0
      CSeq: 1
      Transport: RTP/AVP;unicast;client_port=38212-38213
S->C: RTSP/1.0 200 OK
      CSeq: 1
      Date: Fri, 16 Jun 2006 17:48:55 GMT
      session: 11002-1;timeout=80
      Transport: RTP/AVP;unicast;destination=10.1.231.6;
      client_port=38212-38213;server_port=5020-5021
C->S:  PLAY  rtsp://streaming.cctv.com/programs/cctv5.sdp/streamid=0
RTSP/1.0
      CSeq: 1
      X-Playlist-Seek-Id: 47874
      session: 11002-1
S->C: RTSP/1.0 200 OK
      CSeq: 1
      Date: Fri, 16 Jun 2006 17:48:55 GMT
      session: 11002-1;timeout=80
      Transport: RTP/AVP;unicast;destination=10.1.231.6;
S->C: RTP streaming transportation.....
```

While streaming or playing the Channel 1 content, the terminal 100 also sends another sequence of RTSP DESCRIBE, SETUP, PLAY requests with the Channel 2 URL to the media server 200 to setup a Channel 2 streaming session and play the Channel 2 content. The media server 200 responses with RTSP 200 OK in Step 312, and then RTP streams the Channel 2 content as encoded by the encoder 220 to the terminal 100. It should be understood that the setup of the two channel streaming sessions are not necessarily in the above order, but can be in any order.

After successfully setting up both channel streaming sessions, the terminal 100 may render PiP, i.e. display render both the Channel 1 content and Channel 2 content as streamed over the Channel 1 streaming session and the Channel 2 streaming session on the screen at the same time by using the rendering engine that supports overlay or combination of the contents. The Channel 1 content may be displayed as main channel content in a main window or full screen, and at the same time the Channel 2 content may be displayed as minor channel content in a minor widow that overlays on the main window. The size, position and style of the main window and minor window may be preset by the manufacturer, or be arbitrarily configured and adjusted by the user. The user may enjoy the Channel 1 content, while keeping an eye on the Channel 2 content.

If the user finds Channel 2 content in the minor window more interesting and decides to watch it in a main window, the terminal 100 may display the Channel content 2 in main window or full screen by using the rendering engine 130. The Channel 1 content may be displayed in minor window instead, or not displayed at all. The main channel streaming session may be torn down to save bandwidth. Alternatively, it may be maintained, so that in future the terminal 100 may use fast channel switch to switch to another channel via the existing Channel 1 streaming session without setting up another streaming session. Typically, the terminal 100 may send an RTSP PLAY request that contains a “Switch-Stream” header field describing the replacement of media streams after content switch, and the media server responds with a RTSP PLAY response message containing the “Switch Stream” header field.

The embodiment implementing PiP in a IP-based TV system has been described above. However, till now most terminals are not powerful enough to decode two channel contents of normal quality at the same time. The amount of computations may cause unbearable time delay (or discontinuousness in video and audio) and rapid battery consumption. In addition, transmission of such contents requires relative high network bandwidth.

In view of this, the invention proposes another embodiment for implementing PiP in a IP-based TV system, which can lower the requirements for processing power, battery life and bandwidth.

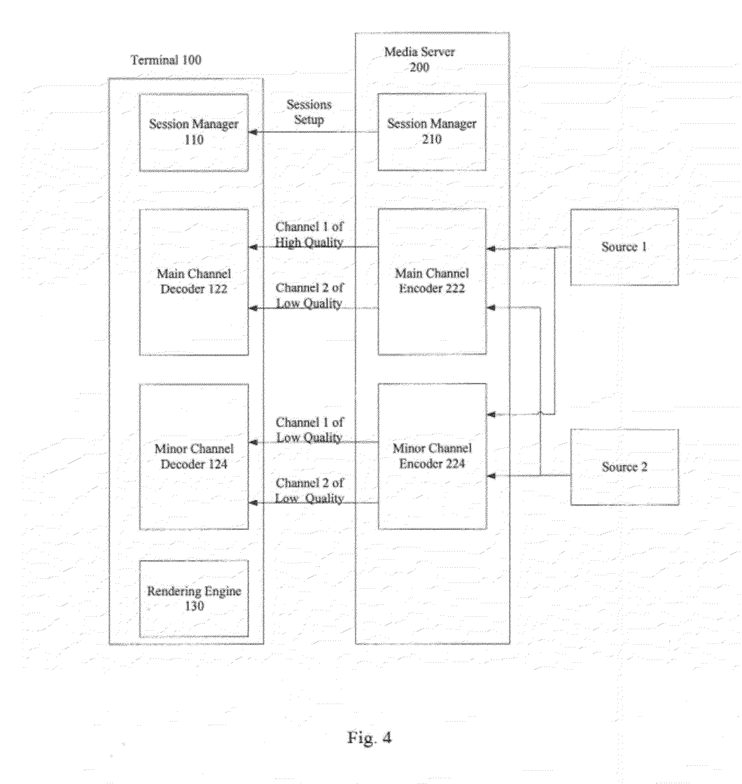

FIG. 4 shows a system overview according to another embodiment of the invention.

In the embodiment, a main channel encoder 222 receives signals from external Source 1 and 2, and encodes them respectively into Channel content 1 and Channel content 2 of higher quality. The minor channel encoder 224 receives signals from external Source 1 or Source 2, and encodes them into Channel content 1 and Channel content 2 of lower quality. For example, the main channel encoder 220 is a H.264 encoder, and the minor channel encoder 230 is a H.263 encoder. On the terminal side, a main channel decoder 122 and a minor channel decoder 124 are correspondingly provided accordingly. The main channel decoder 122 receives and decodes Channel content 1 and Channel content 2 of higher quality, and the minor channel decoder 124 receives and decodes Channel content 1 and Channel content 2 of lower quality. The rendering engine 130 renders channels contents of different quality, e.g. Channel content 1 of higher quality and Channel content 2 of lower quality on the screen in PiP.

The procedure for setting up Channel 1 and Channel 2 sessions in this embodiment is basically the same as that in FIG. 3. Typically, in order to save bandwidth and lower requirements for decoding, the terminal 100 sets up one channel streaming session with the media server 200 to stream a content of higher quality, and sets up another channel streaming session to stream a content of lower quality. For example, the Channel 1 content as streamed on the Channel 1 streaming session is encoded by H.264 and has a higher quality, while the Channel 2 content as streamed on the Channel 2 streaming session is encoded by H.263 and has a lower quality. The terminal 100 may display the Channel 1 content in main window or full screen, and at the same time display Channel 2 content in minor window by using the rendering engine. If the user finds Channel 2 content in the minor window more interesting and decides to watch it in a main window, generally, the terminal 100 may use fast channel switch to switch to Channel 2 content of higher quality as encoded by the main channel encoder 220 via the existing Channel 2 streaming session, and display the Channel 2 content of higher quality in main window or full screen. The terminal 100 may also directly display the Channel 2 content of lower quality in main window or full screen by the rendering engine without the fast channel switch, if the user does not mind the lower quality.

The quality may be represented by e.g. FPS, resolution, bitrate of the stream. Both the higher and lower quality can be preset by the Service Provider, or can vary with network conditions, terminal performance or user preference. According to RTCP standard (RFC 3550), the media server 200 will send RTCP sender report to the terminal 100 and the terminal 100 will send RTCP receiver report to the media server 200. The media server 200 can monitor the streaming quality of the channel contents, especially that of the minor channel content. If the media server 200 finds, for example, the network bandwidth is not enough for streaming minor channel content with specified resolution, bitrate or FPS, the media server may adaptively adjust these parameters. For example, the media server 200 may deliver the minor channel content with a smaller resolution or lower bitrate as generated by the minor channel encoder to the terminal 100, or drop some video frames in the streaming, i.e., reduce the FPS. The media server 200 could do such adaptation in the same RTSP session and RTP streams without notifying the terminal.

Since the terminal 100 only needs to decode one channel content of higher quality and one of lower quality at the same time, instead of two channel contents of higher quality, the requirements for network bandwidth, terminal performance and battery life can be lowered, which is particularly important for the current IP-based mobile TV.

In an alternative embodiment, the minor channel encoder 230 may be simplified as an image encoder, which extracts frames from the external Source 1 and 2 to generate image sequences instead of media stream. Advantageously, the generated image sequences could be of Joint Photographic Experts Group (JPEG) format, due to its high compression rate and dominance in Internet. Preferably, image sequences of difference size and bitrate (mainly decided by the image compression rate) for the same source could be generated simultaneously and sent to the session manager 210. The Frame per Second (FPS) of each image sequence here could be a small fixed value (for example 10 FPS) and for one channel one and more image sequences with different bitrate and size can be generated. Alternatively, the minor channel encoder 230 may generate one image sequence for one channel, and the FPS of the generated image sequence could vary with the network conditions such as bandwidth, or in response to the request from the terminal 100. The terminal 100 may request from streaming server the minor channel content with different size, bitrate, FPS according to network conditions, terminal performance or user preference. It is possible that for different terminals, the size, bitrate and FPS of the image sequences are different. The minor channel decoder 130, which could be an image decoder, decodes the encoded images for display as minor channel content on the screen together with the main channel content.

In this alternative embodiment, the relatively small image (for example, JPEG picture width*height equals 100*75 pixels for handset QVGA screen) sequence is delivered as minor channel content. The requirement for FPS of each image sequence is not high. Due to the relative low FPS, the minor channel content could look like slide show. Unlike the streams encoded with MPEG-4, H.264 or H.263, the images (for example, in JPEG format) in a sequence are independently encoded, which means a failure in transmitting or decoding one image would not affect the decoding of its preceding or subsequent images, and each image could use different compression rate. So more flexibility can be provided for resource schedule. In addition, since most terminals can decode images, such an image sequence solution can be easily applied without increasing complexity in decoder. The switching to the minor channel by transmitting image sequence should be faster as compared with RTP streaming, since it is unnecessary to create a buffer.

Although in FIG. 2 and FIG. 4t the media server is shown as including one or two encoders, it should be understood that the number of encoders is not important to implement the invention. The encoders may be physically integrated in one component, or divided into more components. As such, the number of decoders is not limited to what the drawings show. Many of the elements discussed in this specification, whether referred to as a “encoder” a “decoder” a “manager” a “ engine” or similar, may be implemented in hardware circuit(s), a processor executing software code, or a combination of a hardware circuit and a processor executing code, or other combinations of the above known to those skilled in the art. Those skilled in the art may also recognize that the interconnections between those elements could be implemented in various ways, for example, by hard wires or signal flows.

Although the PiP function is illustrated in the above embodiments wherein both the video from the main channel content and minor channel content are played and overlaid on the screen at the same time, it should be understand that the channel switch should not be limited as between videos. In addition to the PiP function which combines (overlays) video from two channel content, those skilled in the art can conceive any combinations or mix between the video/audio from two or more channel contents. For example, when a user is watching the main channel, he may decide to play the audio from the minor channel instead. The audio from the minor channel may replace the audio from the main channel in case that for example, the user wants to enjoy the music from the minor channel while watching the video program from the main channel. Generally it is not a good idea to play both the main channel audio and minor channel audio at the same time, because the mixed sound may become noisy. However, it is possible that the user may enjoy the main channel video and audio while listening to the audio such as emergency announcement or weather forecast from the minor channel. In another case, the user may be watching the main channel and minor channel video (PiP), but play the minor channel audio instead of the main channel audio. In summary, not only the video but audio can be switched and played between two channel content. Therefore, the term “PiP” should not be narrowly interpreted as combination of videos, but may in principle cover all possibilities of the combination between videos, audios or text. The rendering engine may render not only video but also audio or text, or any combinations thereof.

In the conventional IP-based mobile TV system, the user has to switch the channels one by one to find an interested one, which is rather time consuming and annoying especially considering the relative poor network status of current wireless networks. The PiP solution for IP-based mobile TV according to the invention will help the user to keep an eye on another (other) interested channel(s) without changing the current main channel, and conveniently switch to the other interested channel if necessary. This will certainly improve the user experience for IP-based mobile TV greatly.

To reduce requirements for network bandwidth, terminal performance (processing power) and battery life, it is proposed that channel content of lower quality can be streamed and displayed as minor channel. The low bandwidth requirements secure its applicability on currently deployed commercial 3G networks. It is also proposed to replace the streaming of minor channel with commonly accepted image sequence such as JPEG format with supports to adaptive size, FPS and quality level (mainly decided by JPEG picture compression rate), which also secures a big coverage on already deployed mobile terminals on market. Without the needs to maintain a buffering mechanism in terminal for minor channel, the image sequence brings real “fast channel switch” experience on the minor channel. The user can use overlaid minor channel window as fast channel pre-viewer/selector and activate the program in the minor channel window at any time.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from its central scope. Therefore it is intended that the present invention not be limited to the particular embodiment disclosed as the best mode contemplated for carrying out the present invention, but that the present invention include all embodiments falling within the scope of the appended claims.

1. A method for implementing Picture in Picture (PiP) in an IP-based system by a terminal, said method comprising the steps of:
sending to a media server a first request to setup a first channel streaming session;
sending to the media server a second request to setup and a second channel streaming session; and
rendering first channel content and second channel content as streamed over the first channel streaming session and the second channel streaming session at the same time.

2. The method according to claim 1, wherein the first channel content has a higher quality than the second channel content.

3. The method according to claim 1, further comprising the step of:
requesting access information of the first channel and the second channel.

4. The method according to claim 1, wherein the first channel content is rendered in a main window and the second channel content is rendered in a minor window.

5. The method according to claim 1, wherein the first channel streaming session and the second streaming session are based on Real-Time Streaming Protocol (RTSP) and Real-time Transport Protocol (RTP).

6. The method according to claim 5, wherein the first request and the second request include at least one of RTSP DESCRIBE, SETUP and PLAY requests.

7. The method according to claim 1, wherein the first channel content and the second channel content include at least one of video, audio and text.

8. The method according to claim 7, wherein the video is a sequence of Joint Photographic Experts Group (JPEG) images.

9. The method according to claim 7, wherein at least one parameters for the first channel content and the second channel content are adjustable.

10. The method according to claim 2, further comprising the step of sending to the media server a third request to switch from the second channel content of lower quality to a second channel content of higher quality over the second channel streaming session.

11. A method for implementing Picture in Picture (PiP) in an IP-based system by a media server, said method comprising the steps of:
setting up a first channel streaming session with a terminal in response to a first request from the terminal; and
setting up a second channel streaming session with the terminal in response to a second request from the terminal.

12. A terminal which supports Picture in Picture (PiP) in an IP-based system, said terminal comprising:
a session manager arranged for setting up channel streaming sessions with a media server;
a first decoder arranged for decoding a first channel content which is streamed over a first channel streaming session;
a second decoder arranged for decoding a second channel content which is streamed over a second channel streaming session; and
a rendering engine arranged for rendering the first channel content and the second channel content at the same time.

13. The terminal according to claim 12, wherein the first channel content has a higher quality than the second channel content.

14. The terminal according to claim 12, wherein the session manager sends to the media server a first request to setup the first channel streaming session and sends to the media server a second request to setup the second channel streaming session.

15. The terminal according to claim 12, wherein the session manager requests access information of the first channel and the second channel.

16. The terminal according to claim 12, wherein the first channel content is rendered in main window and the second channel content is rendered in minor window.

17. The terminal according to claim 12, wherein the first channel streaming session and the second streaming session are based on Real-Time Streaming Protocol (RTSP) and Real-time Transport Protocol (RTP).

18. The terminal according to claim 12, wherein the first request and the second request include at least one of RTSP DESCRIBE, SETUP and PLAY requests.

19. The terminal according to claim 12, wherein the first channel content and the second channel content include at least one of video, audio and text.

20. The terminal according to claim 19, wherein the video is a sequence of Joint Photographic Experts Group (JPEG) images.

21. The terminal according to claim 19, wherein at least one parameters among resolution, bitrate and Frame per Second (FPS) of the first channel content and the second channel content are adjustable.

22. The terminal according to claim 13, wherein the session manager sends to the media server a third request to switch from the second channel content of lower quality to a second channel content of higher quality over the second channel streaming session.

23. A media server which supports Picture in Picture (PiP) in an IP-based system, said media server comprising:
a media manager arranged for setting up channel streaming sessions with a terminal;
a first encoder arranged for encoding a first channel content, and
a second encoder arranged for encoding a second channel content.

24. The media server according to claim 23, wherein the first channel content has a higher quality than the second channel content.

25. An IP-based system which supports Picture in Picture (PiP), comprising a terminal according to claim 12.
